(19) United States
(12) Patent Application Publication
(10) Pub. No.: US 2022/0372333 A1
(43) Pub. Date: Nov. 24, 2022

(54) Non-Stick, Polishing Wax

(71) Applicant: Terrence Collins, Spearfish, SD (US)

(72) Inventor: Terrence Collins, Spearfish, SD (US)

(21) Appl. No.: 17/718,389

(22) Filed: Apr. 12, 2022

Related U.S. Application Data
(60) Provisional application No. 63/189,859, filed on May 18, 2021.

(51) Int. Cl. C09G 1/08

(52) U.S. Cl. CPC C09G 1/08; E01H 5/02

(57) ABSTRACT

This present invention relates to a wax designed to create a non-stick, polished surface on snow shovels, snow blower chutes and other devices. The wax comprises of ingredients such as odorless mineral spirits, beeswax and paraffin wax, and can be easily applied using a cloth. Additionally, the unique wax of the present invention offers a rust preventative solution when applied to metal surfaces and enables individuals to utilize the wax as a wood preservative and polish in addition to its other uses.

### CROSS-REFERENCE TO RELATED APPLICATION

The present application claims priority to, and the benefit of, U.S. Provisional Application No. 63/189,859, which was filed on May 18, 2021 and is incorporated herein by reference in its entirety.

### FIELD OF THE INVENTION

The present invention relates generally to the field of wax. More specifically, the present invention relates to a wax that can be applied to snow shovels and snowblower chutes in order to prevent snow from sticking or adhering and building up on the shovel, thereby making the device heavier and more difficult to operate. When applied to snowblower chutes, the wax prevents them from being clogged with snow during use. Additionally, the wax of the present invention offers a rust preventative solution when it's applied to metal surfaces. Further, the wax of the present invention enables the user to use it as a wood preservative and polish in addition to its snow removal equipment application. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, the winter season in cold climates leads to significant snow and ice accumulation on lawns, roofs, sidewalks, driveways, parking lots and other similar areas in many countries around the world. On the one hand, snow accumulation creates a picturesque view for people, while on the other hand it causes a lot of problems for the people living in such areas. One of the problems with snow accumulation is that it makes it difficult for people, animals, and vehicles to use sidewalks, driveways, parking lots and roads. The slippery texture of snow and ice causes problems in creating a grip while travelling on sidewalks and pavement surfaces, and thereby leads to accidents.

Various solutions are available in the state of the art to remove ice and snow from sidewalks, driveways and other similar areas. For example, the use of snow removal equipment and snow melting devices are commonly used by people in many countries for removing accumulation of snow and ice from various surfaces. Snow removal equipment includes snow shovels that generally comprise a handle and a scoop/blade. The snow shovel user holds the grip of the handle and uses the scoop/blade for removing the accumulated snow or ice from various surfaces. Other snow removal equipment includes snow blowers/throwers that are also used by people to quickly remove accumulated snow and ice from sideways, driveways and other similar areas. Typically, snow blowers include an auger that is powered by a motor or engine and is designed to pull accumulated snow into the machine and to throw it in a desired direction as it leaves the discharge chute.

Snow shovels and snow blowers are generally effective at removing snow and ice. However, depending on the outside temperature, snow and ice may stick to the snow shovel scoop and thereby accumulate on the surface of the snow shovel. Snow accumulation on the snow shovel scoop surface adds unnecessary weight to the shovel and reduces the amount of possible snow removal per scoop of the shovel, thereby making a difficult snow removal task even more labor-intensive. Further, snow and ice that gets stuck to snow blower chutes commonly cause the chute to become clogged with heavy, wet snow that prevents the user from being able to effectively operate the device.

Therefore, there exists a long felt need in the art for a solution that allows the snow removal equipment to be easily used and is effective in removing snow and ice accumulated from sideways, driveways and other similar surfaces. There is also a long felt need in the art for a solution that prevents the sticking of snow and ice on blades or scoops of snow shovel device. Additionally, there is a long felt need in the art for a solution that prevents the sticking of snow and ice on snow blower chute surfaces, thus leading to a buildup of snow/ice on the chute. Moreover, there is a long felt need in the art for a solution that allows the snow shovel and snow blower to be easily used for removing snow from driveways, pathways, etc. without getting heavy due to snow buildup on the snow removal equipment. Further, there is a long felt need in the art for a means that minimizes the effort and time needed to complete the snow removal task. Finally, there is a long felt need in the art for a solution that prevents snow blower chutes from becoming clogged, and enables the user to effectively operate the snow removal equipment without having to stop and clean out the chute during the snow removal task.

The subject matter disclosed and claimed herein, in one embodiment thereof, comprises a non-stick, polishing wax that is designed to be applied to a snow shovel blade and a snow blower chute to prevent buildup and adherence of snow. The wax is comprised of odorless mineral spirits, beeswax and paraffin wax, wherein the odorless mineral spirits are approximately 50% by weight, the beeswax is approximately 25% by weight, and the paraffin wax is approximately 25% by weight. In addition, the novel wax can be used to prevent rust on metal surfaces, and as a wood preservative and polish. The novel wax of the present invention is preferably applied to the snow shovel blade and the snow blower chute using a cloth fabric that has been dipped into the novel wax. The odorless mineral spirits act as an organic solvent for the novel wax components.

In this manner, the novel wax of the present invention accomplishes all of the forgoing objectives, and provides a relatively easy, convenient and effective addition to using snow removal equipment such as snow shovels or snow blowers. The wax of the present invention is also user friendly, as it prevents the snow from sticking to and building-up on the surfaces of snow shovel blades or snow blower chutes, thereby making the snow removal task easier for the user.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a novel non-stick, polishing wax designed to be applied to snow removal equipment such as shovel blades and snow blower chutes to prevent adherence and buildup of snow. The wax is comprised of odorless mineral spirits, beeswax and paraffin wax wherein the odorless mineral spirits are preferably 50% by weight, beeswax is preferably 25% by weight and paraffin wax is preferably 25% by weight. Further, the novel wax can also be used to prevent rust on metal surfaces and can also be used as a wood preservative and polish. The novel wax of the present invention is preferably applied to the snow shovel blade and the snow blower chute using a cloth fabric that has been dipped into the novel wax. The odorless mineral spirits act as an organic solvent for the novel wax components.

In a further embodiment of the present invention, a unique solid/paste wax composition for coating the surfaces of snow removal equipment such as snow shovel blades and snow blower chutes to prevent adherence and buildup of snow is disclosed and comprises an odorless mineral spirits component in an amount between approximately 50% to 60% by weight of the total composition, a beeswax component in an amount between approximately 20% to 30% by weight of the total composition and a paraffin wax component in an amount between approximately 25% to 35% by weight of the total composition.

In yet a further embodiment of the present invention, a wax composition to apply on snow shovel blades, snow blower chutes or hockey sticks for preventing buildup of snow and ice is disclosed and consists essentially of an odorless mineral spirits solvent in an amount between approximately 40% to 55% by weight of the total composition, a beeswax component in an amount between approximately 25% to about 30% by weight of the total composition and a paraffin wax component in an amount between approximately 20% to about 35% by weight of the total composition. The present invention provides a unique set of wax compositional specifications that provide improved properties for use of the wax-blend composition in coatings for snow shovels, snow blower chutes, wood, hockey sticks or any other metal or non-metal devices.

The novel wax of the present invention is manufactured in a semi-solid paste consistency. Ideally, the wax can be applied to various surfaces by dipping a cloth fabric into the wax container and rubbing the wax onto the desired surfaces. Alternatively, the novel wax can be formulated into an aerosol spray whereby the wax can be emulsified with water and a plurality of surfactants in various concentrations so that the emulsion wax composition can be sprayed onto a surface.

The advantage of the composition of the present invention is that it prevents snow from sticking, adhering and building up on a surface such as a shovel blade. The shovel does not become heavy while shoveling snow. Further, the invention also assists in preventing snow blower chutes from becoming clogged with snow during use. The invention also acts as a wood preservative and rust preventive solution for metal surfaces.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a diagrammatic representation of the ingredients of one potential embodiment of the novel non-stick, polishing wax of the present invention in accordance with the disclosed architecture;

FIG. 2 illustrates a diagrammatic representation of the ingredients of the beeswax used in one potential embodiment of the non-stick, polishing wax of the present invention in accordance with the disclosed architecture;

FIG. 3 illustrates a perspective view of a user applying one potential embodiment of the novel non-stick, polishing wax of the present invention to a snow shovel blade to prevent adhesion and buildup of snow in accordance with the disclosed architecture;

FIG. 4 illustrates a perspective and side by side comparison of two snow shovels, wherein the novel non-stick, polishing wax of the present invention has been applied to one snow shovel blade to prevent buildup of snow in accordance with the disclosed architecture, but not to the other snow shovel blade;

FIG. 5 illustrates a perspective view of a user applying one potential embodiment of the novel non-stick, polishing wax of the present invention to a snow blower chute to prevent adhesion and buildup of snow in accordance with the disclosed architecture; and

FIG. 6 illustrates a perspective view of application of one potential embodiment of the novel non-stick, polishing wax of the present invention to metal and wood surfaces for rust prevention, polishing and shining in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a solution that allows snow removal equipment to be easily used, and that is effective in removing snow and ice accumulated from sideways, driveways and other similar surfaces. There is also a long felt need in the art for a solution that prevents the sticking of snow and ice on blades or scoops of snow shovel devices. Additionally, there is a long felt need in the art for a solution that prevents the sticking of snow and ice on snow blower chute surfaces, thus leading to a buildup of snow/ice on the chute. Moreover, there is a long felt need in the art for a solution that allows the snow shovel and snow blower to be easily used for removing snow from driveways, pathways, etc. without getting heavy due to snow buildup on the snow removal equipment. Further, there is a long felt need in the art for a means that minimizes the effort and time needed to complete the snow removal task. Finally, there is a long felt need in the art for a solution that prevents the snow blower chutes from becoming clogged, and that enables the user to effectively operate the snow removal equipment without having to stop and clean out the chute during the snow removal task.

The present invention, in one exemplary embodiment, is a novel non-stick, polishing wax that is designed to be applied to a snow shovel blade and/or a snow blower chute to prevent buildup and adherence of snow, comprising of odorless mineral spirits, beeswax and paraffin wax, wherein the odorless mineral spirits are approximately 50% by weight, the beeswax is approximately 25% by weight and the paraffin wax is approximately 25% by weight. In addition, the novel wax can also be used to prevent rust on metal surfaces, and as a wood preservative and polish. The novel wax of the present invention is preferably applied to the snow shovel blade and/or the snow blower chute using a cloth fabric that has been dipped into the novel wax. The odorless mineral spirits act as an organic solvent for the novel wax components

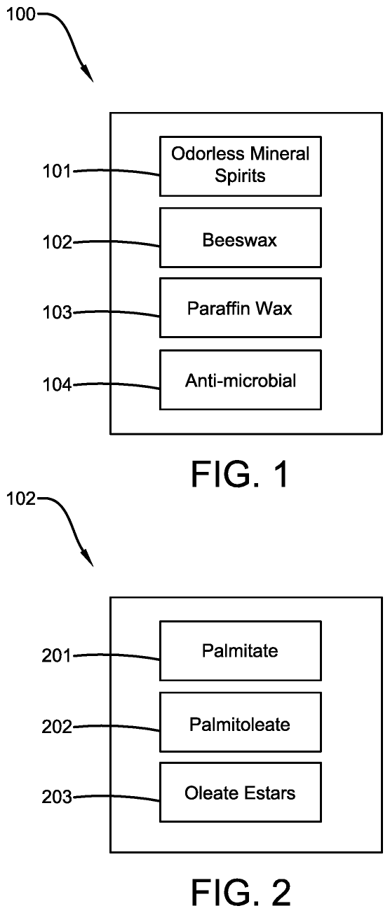

Referring initially to the drawings, FIG. 1 illustrates a diagrammatic representation of the ingredients of one potential embodiment of the novel non-stick, polishing wax 100 of the present invention in accordance with the disclosed architecture. The non-stick, polishing wax 100 of the present invention prevents adherence and buildup of snow on a surface. Additionally, the non-stick, polishing wax 100 has rust-inhibiting properties for metal surfaces, as well as polishing and shining attributes.

Odorless mineral spirits 101 create a soft texture for the novel non-stick, polishing wax 100 and help in the application process of the wax onto a surface, like the spreading of butter onto a piece of toast. The odorless mineral spirits 101 act as a solvent for the non-stick, polishing wax 100 and help in providing polish and shine to a surface such as wood. The odorless mineral spirits 101 also help to wash away grime and dirt on surfaces when the novel wax 100 is applied. Further, the odorless mineral spirits 101 effectively thin and blend well with the other ingredients of the novel wax 100, and do not produce any toxicity.

Beeswax 102 is used in the non-stick, polishing wax 100, which contains natural oils that act as a lubricant to provide a slippery surface and to provide waterproofing properties. The sweet fragrance of the beeswax 102 provides a natural scented smell for the novel wax 100. Beeswax 102 is also a rust inhibitor and provides ultraviolet (UV) protection.

Paraffin wax 103 is added to the novel non-stick, polishing wax to prevent adhesion and buildup of snow and ice on a treated surface. Paraffin wax 103 is derived naturally from crude oil and is biodegradable and non-toxic. Paraffin wax 103 also helps in the melting of snow and ice, and is environmentally friendly, inexpensive and chemically stable. In a further embodiment, the wax 100 may also comprise an anti-microbial agent 104 to reduce the spread of contamination.

When the non-stick, polishing wax 100 is applied to snow removal equipment such as the blade of snow shovel or the chute of a snow blower, snow will not stick to or accumulate on the treated surface. Instead, the snow easily slides off of the treated surface. A single application of the novel wax 100 can continue to be effective for multiple uses of the snow shovel or snow blower.

FIG. 2 illustrates a diagrammatic representation of the ingredients of the beeswax 102 used in one potential embodiment of the non-stick, polishing wax 100 of the present invention in accordance with the disclosed architecture. The beeswax 102 of the present invention preferably comprises palmitate 201, a common fatty acid, which acts as an effective lubricant. The beeswax 102 also preferably contains palmitoleate 202, which is another fatty acid and is a naturally-occurring oil. Additionally, the beeswax 102 also comprises oleate esters 203, which is another type of a fatty acid. The three components of the beeswax 102 combine to create the non-stick lubrication for a treated surface on which the novel wax 100 is applied.

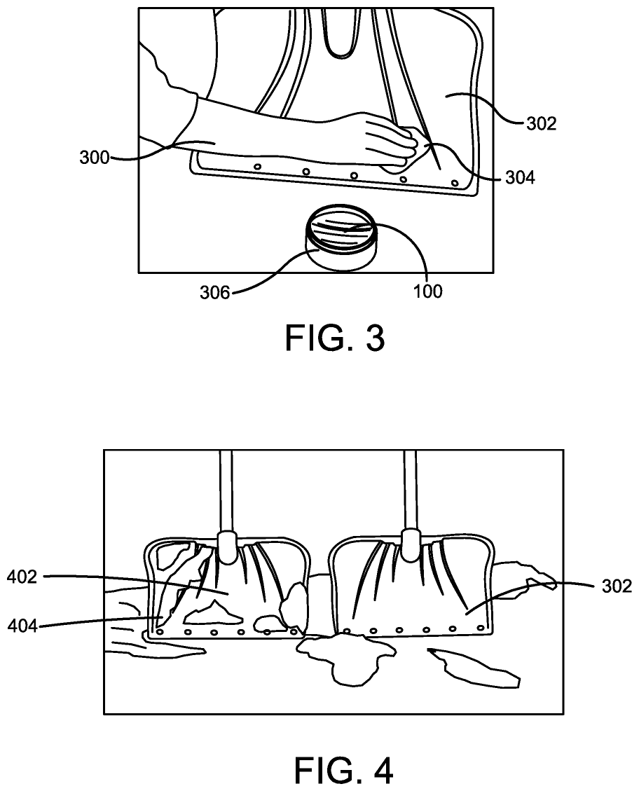

FIG. 3 illustrates a perspective view of a user 300 applying one potential embodiment of the novel non-stick, polishing wax 100 of the present invention to a snow shovel blade 302 to prevent adhesion and buildup of snow in accordance with the disclosed architecture. The non-stick, polishing wax 100 is preferably manufactured as a semi-solid paste, blended from the ingredients listed herein and may be packaged in a container 306 having any convenient size and shape. The novel wax 100 is applied onto a surface, such as a snow shovel blade 302, using a cloth 304 by a user 300. The novel wax 100 is removed from the container 306 using the cloth 304, and is then applied and rubbed into the surface of the snow shovel blade 302. In one embodiment, fragrance and coloring agents may be added to the formulation of the novel wax 100.

FIG. 4 illustrates a perspective and side-by-side comparison of two snow shovels, wherein the novel non-stick, polishing wax 100 of the present invention has been applied to one snow shovel blade 302 to prevent buildup of snow in accordance with the disclosed architecture, but not to the other snow shovel blade 402. As shown, snow 404 does not stick and accumulate on the shovel blade 302 that has been previously treated with the novel wax 100 of the present invention. The snow slides off easily from the treated blade 302. Conversely, an untreated snow shovel blade 402 shows sticking and accumulating snow 404. Thus, the operation of shoveling snow becomes more time consuming and more laborious when the novel wax 100 is not applied to a snow shovel blade 402.

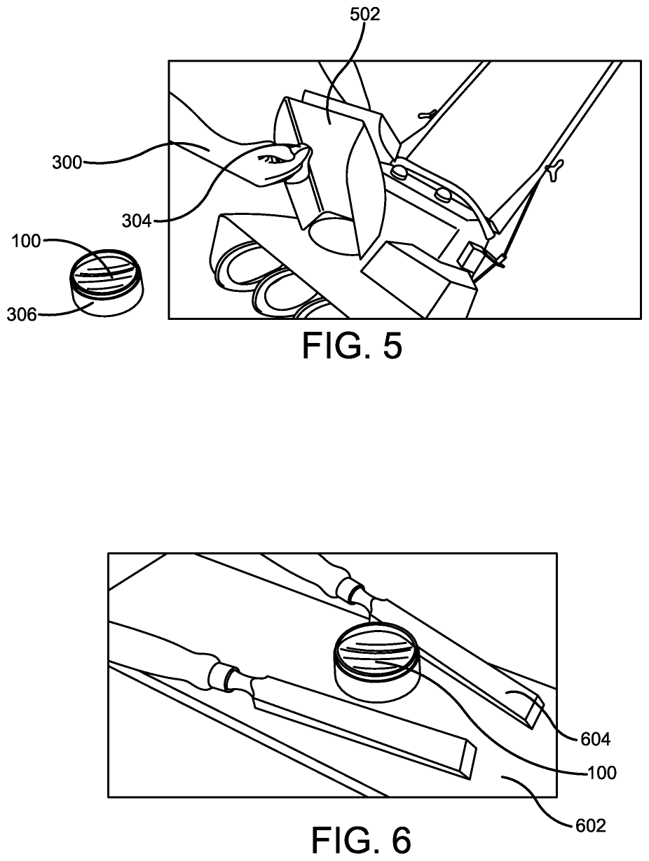

FIG. 5 illustrates a perspective view of a user 300 applying one potential embodiment of the novel non-stick, polishing wax 100 of the present invention to a snow blower chute 502 to prevent adhesion and buildup of snow in accordance with the disclosed architecture. More specifically, as shown, the novel wax 100 is preferably in a semi-solid paste form and is applied on the interior surface of the snow blower chute 502 using a cloth 304 by a user 300. The novel wax 100 is removed from the container 306 using the cloth 304, and is then applied and rubbed into the surface of the snow blower chute 502. The clogging of the chute 502 due to snow accumulation does not take place after the application of the novel wax 100 on the chute surface 502.

FIG. 6 illustrates application of the novel non-stick, polishing wax of the present invention on metal and wood surfaces for rust prevention, polishing and shining. The novel non-stick, polishing wax 100 provides a smooth and shiny finish to a wood surface 602 or a metal surface 604. The novel non-stick, polishing wax 100 may be applied to any kind of wood to protect it from drying out and to restore the wood's natural beauty. The novel non-stick, polishing wax 100 is creamy, unscented and clear and can be easily applied. The novel non-stick, polishing wax 100 can be applied to a soft cotton cloth, and then applied to any desired surface.

Referring to Table 1, there is disclosed a novel non-stick, polishing wax 100 composition having a number of different components in varying quantities in order to achieve a desired result. One such exemplary embodiment of the novel non-stick, polishing wax 100 is provided as shown in Table 1.

| Component | Content in percentage by weight (% w/w) |
|---|---|
| Odorless Mineral Spirits | 50-60 |
| Beeswax | 20-30 |
| Paraffin wax | 25-35 |

TABLE 2
discloses an alternative composition of the novel non-stick, polishing
wax 100 in varying quantities in order to achieve a desired result.

| Component | Percentage by weight (% w/w) |
|---|---|
| Odorless Mineral Spirits | 40-55 |
| Beeswax | 25-30 |
| Paraffin wax | 20-35 |

In a further preferred embodiment of the present invention, the non-stick, polishing wax 100 is preferably comprised of approximately 50 percent by weight of odorless mineral spirits 101, approximately 25 percent by weight of beeswax 102, and approximately 25 percent by weight of paraffin wax 103. Additionally, the novel non-stick, polishing wax 100 may be preferably available in 4, 6, 8 or 10-ounce containers 306. The container 306 may have a logo, indicia or trademark in customizable colors and fonts, embroidery and prints and/or other images on the surface. The containers 306 may be of any suitable shape and size including. but not limited to, rectangular, cubic, pyramidal, cylindrical, spherical or any other shape.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “non-stick, polishing wax”, “lubricating and non-stick, polishing wax”, “novel wax”, and “novel non-stick, polishing wax” are interchangeable and refer to the lubricating and non-stick, polishing wax 100 of the present invention.

Notwithstanding the forgoing, the non-stick, polishing wax 100 of the present invention can contain any additional ingredient known in the art without affecting the overall concept of the invention, provided that it accomplishes the above-stated objectives. One of ordinary skill in the art will appreciate that the ingredients and composition of the non-stick, polishing wax 100 as shown in the FIGS. are for illustrative purposes only, and that many other compositions are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A non-stick, polishing wax comprising:
a quantity of mineral spirits;
a beeswax; and
a paraffin wax.

2. The non-stick, polishing wax as recited in claim 1, wherein the quantity of mineral spirits is odorless.

3. The non-stick, polishing wax as recited in claim 2, wherein the beeswax comprises a palmitate.

4. The non-stick, polishing wax as recited in claim 3, wherein the beeswax comprises a palmitoleate.

5. The non-stick, polishing wax as recited in claim 4, wherein the beeswax comprises an oleate ester.

6. The non-stick, polishing wax as recited in claim 5, wherein a quantity of the mineral spirits is between 40-60 percent by weight of the non-stick, polishing wax.

7. The non-stick, polishing wax as recited in claim 6, wherein a quantity of the beeswax is between 25-30 percent by weight of the non-stick, polishing wax.

8. The non-stick, polishing wax as recited in claim 7, wherein a quantity of the paraffin wax is between 20-35 percent by weight of the non-stick, polishing wax.

9. The non-stick, polishing wax as recited in claim 5, wherein a quantity of the mineral spirits is approximately 50 percent by weight of the non-stick, polishing wax.

10. The non-stick, polishing wax as recited in claim 9, wherein a quantity of the beeswax is approximately 25 percent by weight of the non-stick, polishing wax.

11. The non-stick, polishing wax as recited in claim 10, wherein a quantity of the paraffin wax approximately 25 percent by weight of the non-stick, polishing wax.

12. A non-stick, polishing wax comprising:
a semi-solid paste comprised of an odorless mineral spirit, a beeswax and a paraffin wax.

13. The non-stick, polishing wax as recited in claim 12, wherein the beeswax comprises a palmitate.

14. The non-stick, polishing wax as recited in claim 13, wherein the beeswax comprises a palmitoleate.

15. The non-stick, polishing wax as recited in claim 14, wherein the beeswax comprises an oleate ester.

16. The non-stick, polishing wax as recited in claim 15, wherein a quantity of the mineral spirits is between 40-60 percent by weight of the non-stick, polishing wax.

17. The non-stick, polishing wax as recited in claim 16, wherein a quantity of the beeswax is between 25-30 percent by weight of the non-stick, polishing wax.

18. The non-stick, polishing wax as recited in claim 17, wherein a quantity of the paraffin wax is between 20-35 percent by weight of the non-stick, polishing wax.

19. The non-stick, polishing wax as recited in claim 12, wherein a quantity of the mineral spirits is approximately 50 percent by weight of the non-stick, polishing wax, a quantity of the beeswax is approximately 25 percent by weight of the non-stick, polishing wax, and a quantity of the paraffin wax approximately 25 percent by weight of the non-stick, polishing wax.

20. A non-stick, polishing wax comprising:
a quantity of mineral spirits;
a beeswax;
a paraffin wax; and
an anti-microbial.
